(19) United States
(12) Patent Application Publication
(10) Pub. No.: US 2011/0072320 A1
(43) Pub. Date: Mar. 24, 2011

(54) CACHE SYSTEM AND CONTROL METHOD THEREOF, AND MULTIPROCESSOR SYSTEM

(75) Inventor: Takashi MIURA, Kanagawa (JP)

(73) Assignee: KABUSHIKI KAISHA TOSHIBA, Tokyo (JP)

(21) Appl. No.: 12/881,381

(22) Filed: Sep. 14, 2010

(30) Foreign Application Priority Data
Sep. 18, 2009 (JP) 2009-217598

(51) Int. Cl. G06F 11/16; G06F 11/00; G06F 12/08

(52) U.S. Cl. 714/54; 711/137; 714/E11.056; 711/E12.001; 711/E12.057; 711/E12.02

(57) ABSTRACT

According to the embodiments, a cache system includes a cache-data storing unit and a failure detecting unit. The failure detecting unit detects failure in units of cache line by determining whether instruction data prefetched from a lower layer memory matches cache data read out from the cache-data storing unit. A cache line in which failure is detected is invalidated.

### CROSS-REFERENCE TO RELATED APPLICATIONS

This application is based upon and claims the benefit of priority from the prior Japanese Patent Application No. 2009-217598, filed on Sep. 18, 2009; the entire contents of all of which are incorporated herein by reference.

### FIELD

Embodiments described herein relate generally to a cache system and a control method thereof, and a multiprocessor system.

### BACKGROUND

In a multiprocessor system that configures a symmetrical multiprocessor LSI with one chip, each microprocessor executes the same instruction code simultaneously in some cases. For avoiding stall due to a bus contention accompanied by an instruction fetch by each microprocessor, an instruction cache is mounted on each microprocessor in most systems. The instruction cache typically consists of a cache tag portion (hereinafter, arbitrarily referred to as “tag portion”) and an instruction memory portion (hereinafter, arbitrarily referred to as “memory portion”) that includes a typical SRAM (for example, see Japanese Patent Application Laid-open No. 2006-343851 for the cache memory).

The memory portion is strictly tested in an LSI inspection for securing a normal operation of enabling supply of correct instruction data to an instruction execution unit in the case of a cache hit. Typically, in the memory portion, failure of a storage element easily occurs at the lowest voltage and the highest frequency on a specification. A quality determination is performed under such a severe condition, and if failure occurs in any of a plurality of the microprocessors, the LSI as a whole is determined as defective even if it operates normally at a typical voltage or driving frequency. As a method to avoid such determination and prevent abnormal execution of the system, for example, a technology is known, in which a redundant storage portion is provided in the memory portion of each microprocessor and a defective part is switched to a normal part. In this case, redundancy is given for each microprocessor, so that a redundant area increases in proportion to the number of the microprocessors. Thus, the microprocessor system that configures the symmetrical multiprocessor LSI with one chip has problems that yield decreases and a manufacturing cost increases compared with a configuration in which a plurality of single microprocessor chips is combined.

Moreover, there is a technology in which the microprocessor in which defect occurs in the memory portion is set to unused and a process is executed by a different normal microprocessor by an application of the LSI to satisfy a required performance that the LSI is required to process. In addition, there is also a case of maintaining yield as a whole by lowering the specification for the microprocessor in which defect occurs in the memory portion. There is a problem in both of the cases that the microprocessor is uniquely set to unused, so that the performance as the LSI is significantly lowered, which leads to decrease in a sales price because of limitation of an applicable application.

### BRIEF DESCRIPTION OF THE DRAWINGS

FIG. 1 is a block diagram illustrating a configuration of a processor system that includes a cache system according to a first embodiment;

FIG. 2 is a diagram illustrating a correspondence example of a data structure of a tag unit and line data;

FIG. 3 is a diagram illustrating a configuration example of the tag unit with respect to a cache with 2^{m} lines; and

FIG. 4 is a block diagram illustrating a configuration of a processor system according to a second embodiment.

### DETAILED DESCRIPTION

According to embodiments, a cache system includes a cache-data storing unit and a failure detecting unit. The cache-data storing unit stores therein cache data. The failure detecting unit detects failure of the cache-data storing unit. The failure detecting unit detects failure in units of cache line by determining whether instruction data prefetched from a lower layer memory matches cache data read out from the cache-data storing unit. A cache line in which failure is detected is invalidated.

A cache system and a control method thereof, and a processor system according to the embodiments will be explained below in detail with reference to the accompanying drawings. The present invention is not limited to these embodiments.

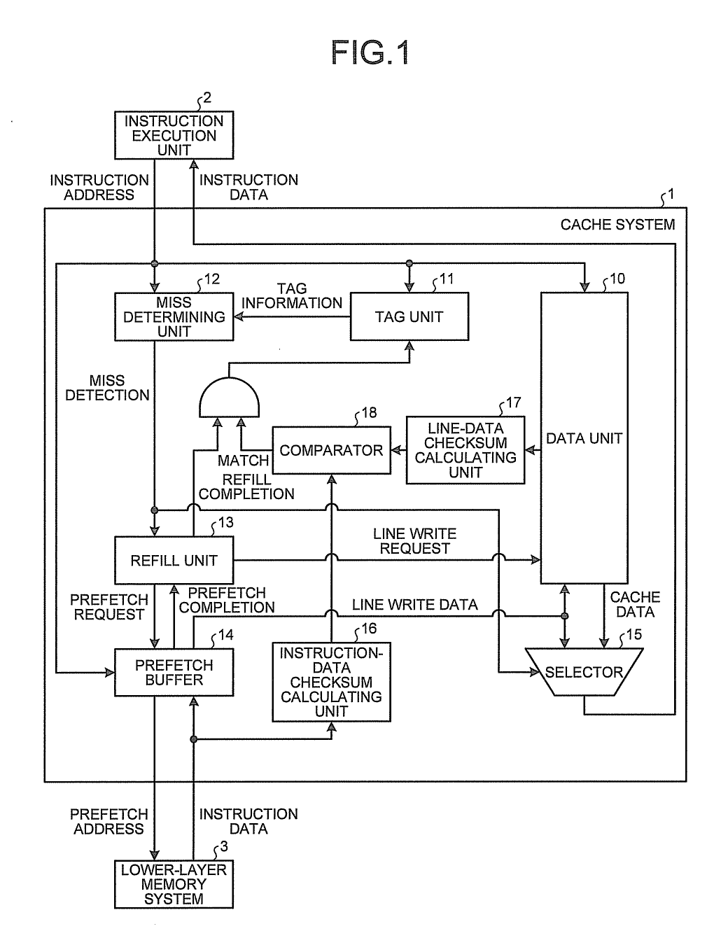

FIG. 1 is a block diagram illustrating a configuration of a processor system that includes a cache system 1 according to a first embodiment. The processor system according to the present embodiment is a multiprocessor system that includes a plurality of processors including the cache system 1. FIG. 1 illustrates the configuration necessary for explanation of the present embodiment in the multiprocessor system. An instruction execution unit 2 is a CPU (Central Processing Unit) for controlling an operation of the multiprocessor system and executes a program stored in an external memory. A lower-layer memory system 3 is a memory in a lower hierarchy with respect to the cache system 1.

The cache system 1 includes a data unit 10, a tag unit 11, a miss determining unit 12, a refill unit 13, a prefetch buffer 14, a selector 15, an instruction-data checksum calculating unit 16, a line-data checksum calculating unit 17, and a comparator 18.

The data unit 10 functions as a cache-data storing unit in which cache data is stored in units of cache line. The tag unit 11 stores therein cache-line tag information on the cache data. The miss determining unit 12 determines hit or miss of a cache access by comparing a tag of an instruction address accessed to the cache system 1 with the cache-line tag information read out from the tag unit 11, and outputs a miss detection signal indicating the determination result.

The refill unit 13 sends out a prefetch request to the prefetch buffer 14 and a line write request to the data unit 10. The prefetch buffer 14 stores therein instruction data prefetched from the lower-layer memory system 3. The selector 15 selects hit cache line data.

The instruction-data checksum calculating unit 16 functions as an instruction-data checksum calculating unit that calculates an instruction-data checksum. The instruction-data checksum is a checksum of the prefetched instruction data. The line-data checksum calculating unit 17 functions as a line-data checksum calculating unit that calculates a line-data checksum. The line-data checksum is a checksum of the cache data stored in the data unit 10.

The comparator 18 functions as a comparing unit that compares the instruction-data checksum calculated in the instruction-data checksum calculating unit 16 and the line-data checksum calculated in the line-data checksum calculating unit 17. The instruction-data checksum calculating unit 16, the line-data checksum calculating unit 17, and the comparator 18 function as a failure detecting unit that detects failure of the data unit 10. In the present embodiment, “failure” indicates a partial failure of a cache such as a specific bit toggle failure in an SRAM included in the data unit 10 and a specific line readout failure in the SRAM.

The instruction execution unit 2 transmits the instruction address of an instruction that needs to be executed to the cache system 1 and requests for the instruction data. The instruction address is input to the data unit 10, the tag unit 11, the miss determining unit 12, and the prefetch buffer 14. The tag unit 11 supplies validity information on the cache data prestored in the data unit 10 to the miss determining unit 12 as tag information. The miss determining unit 12 determines hit or miss of the cache access based on the instruction address and the tag information.

When the miss determining unit 12 determines that hit occurs, the miss determining unit 12 outputs, for example, “0” as the miss detection signal. The selector 15, upon detecting the miss detection signal “0”, selects the cache data read out from the data unit 10 and supplies it to the instruction execution unit 2 as the instruction data.

When the miss determining unit 12 determines that miss occurs, the miss determining unit 12 outputs, for example, “1” as the miss detection signal. The refill unit 13, upon detecting the miss detection signal “1”, makes a prefetch request to the prefetch buffer 14. The prefetch buffer 14 preferentially transmits the instruction address to the lower-layer memory system 3 as the prefetch address in response to the prefetch request. Data on the prefetch address that is accessed is transmitted from the lower-layer memory system 3 to the cache system 1 as the instruction data.

The instruction data from the lower-layer memory system 3 is supplied to the prefetch buffer 14 with the highest priority. The prefetch buffer 14 places the value of the supplied instruction data on line write data and supplies it to the data unit 10 and the selector 15. The selector 15, upon detecting the miss detection signal “1”, selects the instruction data placed on the line write data. The instruction data selected in the selector 15 is supplied to the instruction execution unit 2.

The prefetch buffer 14 stores therein the instruction data supplied from the lower-layer memory system 3 and places the values of the instruction data sequentially on the line write data to supply to the data unit 10 and the selector 15. Moreover, the prefetch buffer 14 notifies the refill unit 13 of a prefetch completion after storing all of the instruction data. When the refill unit 13 receives the notification of the prefetch completion, the refill unit 13 makes the line write request to the data unit 10 and notifies of a refill completion. The data unit 10 stores the line write data in a line address corresponding to the instruction address from the instruction execution unit 2 in response to the line write request.

The instruction-data checksum calculating unit 16 reads the instruction data in synchronization with the storing of the instruction data into the prefetch buffer 14. The instruction-data checksum calculating unit 16 calculates the instruction data checksum for the read instruction data and outputs the calculation result.

The line-data checksum calculating unit 17 reads the line write data stored in the data unit 10. The line-data checksum calculating unit 17 calculates the line data checksum for the read line data and outputs the calculation result.

The comparator 18 compares the instruction data checksum output from the instruction-data checksum calculating unit 16 with the line data checksum output from the line-data checksum calculating unit 17 and generates a match signal corresponding to the comparison result. The comparator 18 generates the match signal indicating true when the instruction data checksum matches the line data checksum and generates the match signal indicating false when the instruction data checksum does not match the line data checksum. The match signal is output to the data unit 10 in synchronization with the refill completion. The failure detecting unit determines whether the instruction data prefetched from the lower-layer memory system 3 matches the cache data read out from the data unit 10 by comparing the checksums.

The failure detecting unit can perform a failure detection that is easier and faster than comparing the instruction data with the cache data bit by bit, by determining whether the instruction data matches the cache data through comparison of the instruction data checksum and the line data checksum.

The tag unit 11, upon detecting the refill completion, updates the cache-line tag information. The cache-line tag information updated in the tag unit 11 is updated as valid only when the refill completion is detected and the match signal is true. Even if the refill completion is detected, if the match signal is false, a valid flag of the tag unit 11 is forcibly set OFF. In this manner, when updating the cache-line tag information by the cache miss, the cache-line tag information corresponding to the cache line in which failure is detected is invalidated.

When the instruction data prefetched from the lower-layer memory system 3 matches the cache data read out from the data unit 10, the multiprocessor system directly executes the instruction. From the next access to the same instruction address, the cache data read out from the data unit 10 is used.

When the instruction data prefetched from the lower-layer memory system 3 does not match the cache data read out from the data unit 10, the multiprocessor system determines that the cache access does not hit and reads out the instruction data from the lower-layer memory system 3 again. In this manner, the multiprocessor system can reduce an abnormal execution of the system due to occurrence of failure in the cache. Moreover, if the system can functionally operate correctly even if failure occurs in part of the data unit 10, the system can be treated without being uniquely determined as defective, so that the multiprocessor system can increase the yield and maintain the performance required for the system.

It is sufficient that the cache system 1 is one in which the match signal from the failure detecting unit is added to a conventional configuration in which the cache-line tag information is made valid in accordance with the refill completion, so that a conventionally employed circuit can be directly used for the tag unit 11. The configuration for rewriting between hit and miss in accordance with the match signal can be realized by a relatively small-scale logic circuit.

The multiprocessor system according to the present embodiment can eliminate the need of a quality determination under a severe condition in an inspection performed at a manufacturing test of an LSI and at power-up and simplify direct writing and readout of data to the data unit 10. Whereby, the inspection at the manufacturing test and power-up can be simplified and the time required for the inspection can be shortened. Moreover, a start-up time of the system can be shortened due to improvement in efficiency of the inspection performed at power-up.

It is applicable to provide a line failure flag in the tag unit 11 and invalidate the cache line by forcibly treating the case where the line failure flag is set ON similarly to the cache miss. The line failure flag can be appropriately updated in accordance with the detection result by the failure detecting unit. Moreover, when the line failure flag is once set ON, the line failure flag can be dynamically switched from OFF to ON at power-up or program operation or can be fixed ON. Furthermore, when there is the cache access to the cache line in which the line failure flag is set ON, the failure detecting unit can stop the operation for the failure detection. The multiprocessor system can suppress power consumption by enabling to stop unnecessary circuit operation for an access to the cache line in which failure is recognized.

The failure detecting unit is not limited to the case of determining whether the instruction data matches the cache data by comparing the instruction data checksum with the line data checksum. The failure detecting unit can determine whether the instruction data matches the cache data by determining whether the value of the instruction data exactly matches the value of the cache data. In this case, it is possible to determine whether the instruction data matches the cache data with high accuracy.

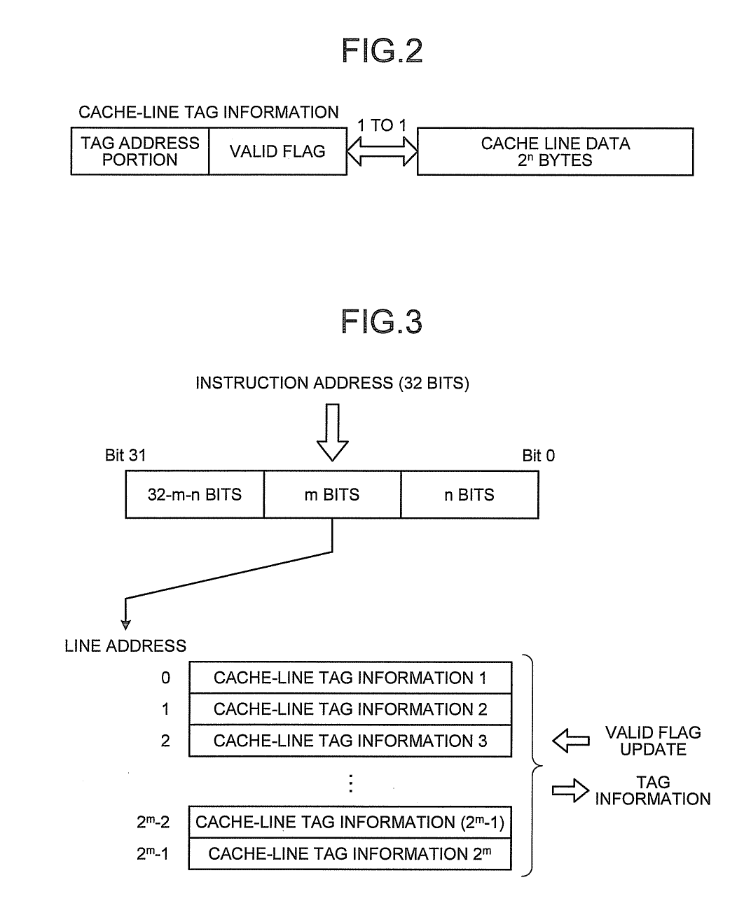

FIG. 2 is a diagram illustrating a correspondence example of a data structure of the tag unit 11 and the line data. In the present embodiment, the tag unit 11 holds the cache-line tag information indicating an address from which the instruction data stored in the data unit 10 is read to have a one-to-one correspondence with the cache line data. The cache-line tag information includes a tag address portion and a valid flag.

Explanation is given for the case where the address information is 32 bits and a direct map cache having totally 2^{m} lines that holds 2ⁿ byte instruction data for one cache line is used an example. The inside of the tag unit 11 is configured to include a memory. FIG. 3 is a diagram illustrating a configuration example of the tag unit 11 with respect to a cache with 2^{m} lines. The tag information on each cache line can be realized as an array memory with the line address as an index.

When 32-bit instruction address is supplied from the instruction execution unit 2 to the tag unit 11 configured as shown in FIG. 3, the address information is resolved into (32-m-n) bits, m bits, and n bits. The m bits in the middle are extracted as the line address and the readout result thereof is supplied to the miss determining unit 12 as the tag information.

When the valid flag is OFF or when the valid flag is ON and the tag information in the miss determining unit 12 is different from the instruction address supplied to the tag unit 11, the miss determining unit 12 treats the access as the cache miss. At the time when the refill operation due to this cache miss is completed, the tag unit 11 sets the valid flag ON for the cache line tag information indicated by the line address represented by the m bits in the instruction address supplied to the tag unit 11. Thereafter, the tag unit 11 repeats these operations every time the instruction address is supplied.

In the present embodiment, the valid flag of the cache-line tag information held by the tag unit 11 includes one that is provided with a line failure bit indicating a line failure other than the normal valid bit as an example. When failure of the cache line is detected in a test operation or the like in a manufacturing stage of the multiprocessor system or at system start-up, the line failure bit that is at first set OFF is switched ON. Only when the valid flag is ON and the line failure bit is OFF, the miss determining unit 12 determines the cache as valid and operates. When the line failure bit is set ON, the miss determining unit 12 always operates similarly to the case of the cache miss and obtains correct instruction data from the lower-layer memory system 3.

Alternatives to introduction of the line failure bit include one in which a line lock bit is provided in the valid flag as an example. The line lock bit is a bit for fixing a state of hit stored in the cache in the microprocessor. Even if the cache miss occurs in which the address portion included in the tag information is different from the instruction address, when the line lock bit is ON, the cache system 1 suppresses update of the cache-line tag information in the tag unit 11 and the cache line data in the data unit 10.

Normally, the microprocessor uses only part of the whole memory area as a valid cache area, so that a non-cache area that is invalid as the cache is typically present. In the example of providing the line lock bit in the valid flag, for example, an address indicating the non-cache area is forcibly registered in the tag address portion and the line lock bit and the valid flag are set ON. Thereafter, the cache line is suppressed to operate as the cache, thus enabling to avoid failure.

Next, the performance of the present embodiment is explained with a system LSI on which an 8-Kbyte 2-way set associative instruction cache and eight 32-bit processors that are driven at 333 MHz are mounted as an example. In this system LSI, audio data (44.1 KHz) in the MP3 format is decoded in 50 frames and 56 tasks in parallel. At this time, in the system LSI with no defect in the SRAM of the instruction cache, the load status is evaluated at about 50% as a whole. Assuming that failure temporarily occurs in 50% of the SRAM of one processor in the same system, even in a status where the instruction data is always supplied from the lower layer memory, the performance degradation as a whole is, for example, about 0.05%. In this manner, even if failure occurs in part of the SRAM of the instruction cache, if the correct instruction execution is possible, the required performance as the LSI can be sufficiently maintained, so that the LSI can be used as a quality product.

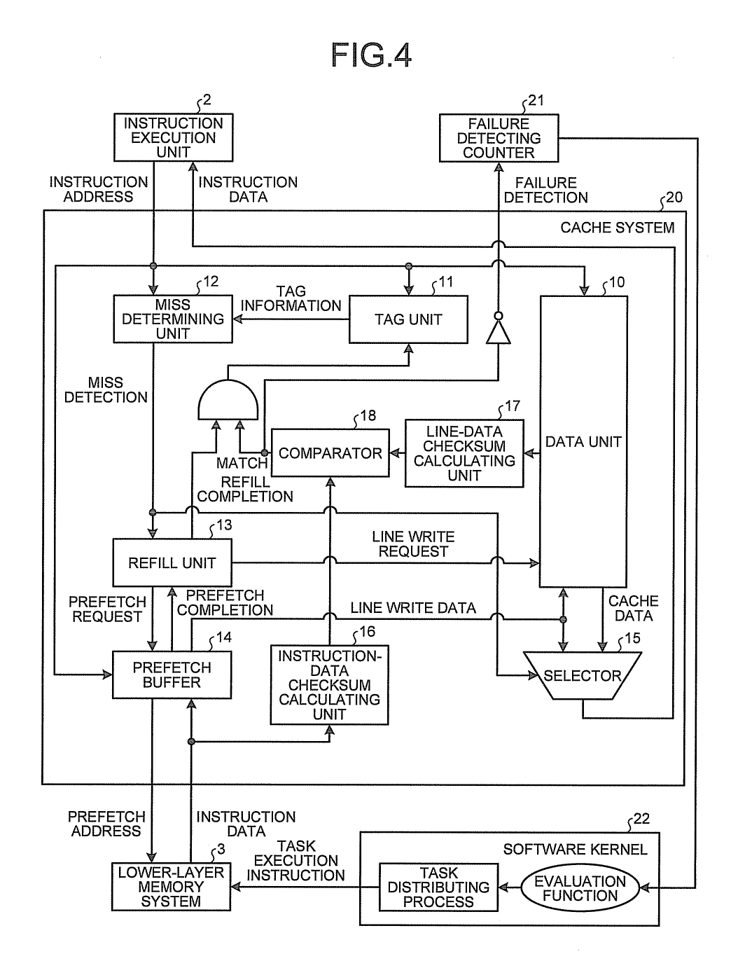

FIG. 4 is a block diagram illustrating a configuration of the processor system according to a second embodiment. The processor system according to the second embodiment is characterized in that tasks with respect to a plurality of processors are distributed in accordance with a frequency at which failure is detected by the failure detecting unit. Components same as those in the first embodiment are represented by the same reference numerals, and overlapping explanation is omitted. FIG. 4 illustrates a configuration necessary for explaining the present embodiment in the multiprocessor system.

A cache system 20 outputs a mismatch signal obtained by inverting the match signal from the comparator 18 to a failure detecting counter 21 as a failure detection signal. The failure detecting counter 21 is provided for each processor. The failure detecting counter 21 counts the number of times of a failure detection. It is applicable that the failure detecting counter 21 outputs a count as a signal to the outside of the processor or is mounted as a register of which count is readable by an access from the outside of the processor.

A software kernel 22 distributes software processes to each processor of the multiprocessor system. The software kernel 22 functions as a task distributing unit that performs a task distributing process of allocating to each processor from an evaluation function in which the count value by the failure detecting counter 21 is used as a parameter. The evaluation function is, for example, a comparison of a predetermined threshold and the count value, and can be appropriately set by a user. The software kernel 22 instructs a task execution to the lower-layer memory system 3 or the like of each processor.

The multiprocessor system monitors increase of the count by the failure detecting counter 21 and causes the software kernel 22 to distribute the tasks to each processor so that the count does not increase. The tasks are distributed while avoiding the processor in which failure of the SRAM easily occurs, so that the processor that may adversely affect the system due to failure exceeding a predetermined frequency is stopped or the load to the processor is reduced. Whereby, the multiprocessor system can reduce the load to the performance of the whole system. Moreover, the multiprocessor system can improve responses to the rapid load variations and reduce the power consumption accompanied by bus access. The multiprocessor system can achieve avoiding performance degradation and decreasing in the power consumption by a relatively simple addition of software.

The software kernel 22 is not limited to the one that performs the task distributing process from the evaluation function in which the count value by the failure detecting counter 21 is used as the parameter. It is sufficient that the software kernel 22 performs the distribution of the tasks in accordance with the frequency at which failure is detected by the failure detecting unit and, for example, can perform the distribution of the tasks by calculating the possibility of detecting the failure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cache system comprising:
a cache-data storing unit that stores therein cache data; and
a failure detecting unit that detects failure of the cache-data storing unit, wherein
the failure detecting unit detects failure in units of cache line by determining whether instruction data prefetched from a lower layer memory matches the cache data read out from the cache-data storing unit, and
a cache line in which failure is detected is invalidated.

2. The cache system according to claim 1, further comprising a tag unit in which cache-line tag information on the cache data is stored, wherein
the tag unit invalidates the cache-line tag information corresponding to the cache line in which failure is detected, when updating the cache-line tag information.

3. The cache system according to claim 1, wherein
the failure detecting unit includes
an instruction-data checksum calculating unit that calculates an instruction data checksum that is a checksum of the instruction data,
a line-data checksum calculating unit that calculates a line data checksum that is a checksum of the cache data, and
a comparing unit that compares the instruction data checksum with the line data checksum.

4. The cache system according to claim 3, wherein the comparing unit outputs a comparison result of the instruction data checksum with the line data checksum in synchronization with completion of refill to the cache-data storing unit.

5. The cache system according to claim 1, wherein the failure detecting unit stops an operation for a failure detection with respect to a cache access to the cache line in which failure is already detected.

6. The cache system according to claim 1, wherein the failure detecting unit determines whether a value of the instruction data exactly matches a value of the cache data.

7. The cache system according to claim 2, wherein the cache-line tag information includes a line failure bit indicating whether failure is detected.

8. A method of controlling a cache system, comprising:
storing instruction data supplied from a lower layer memory in a cache-data storing unit as cache data;
detecting failure in units of cache line by determining whether the instruction data prefetched from the lower layer memory matches the cache data read out from the cache-data storing unit; and
invalidating the cache line in which failure is detected.

9. The method according to claim 8, further comprising:
storing cache-line tag information on the cache data in a tag unit; and
invalidating the cache-line tag information corresponding to the cache line in which failure is detected, when updating the cache-line tag information.

10. The method according to claim 8, wherein
the detecting the failure is performed by
calculating an instruction data checksum that is a checksum of the instruction data,
calculating a line data checksum that is a checksum of the cache data, and
comparing the instruction data checksum with the line data checksum.

11. The method according to claim 10, further comprising outputting a comparison result of the instruction data checksum with the line data checksum in synchronization with completion of refill to the cache-data storing unit.

12. The method according to claim 8, further comprising stopping an operation for a failure detection with respect to a cache access to the cache line in which failure is already detected.

13. The method according to claim 8, wherein the detecting the failure is performed by determining whether a value of the instruction data exactly matches a value of the cache data.

14. The method according to claim 8, further comprising suppressing update of the cache-line tag information and the cache data for the cache line in which failure is detected.

15. A multiprocessor system comprising a plurality of processors that each includes a cache system, wherein
the cache system includes
a cache-data storing unit that stores therein cache data, and
a failure detecting unit that detects failure of the cache-data storing unit,
the failure detecting unit detects failure in units of cache line by determining whether instruction data prefetched from a lower layer memory matches the cache data read out from the cache-data storing unit, and
a cache line in which failure is detected is invalidated.

16. The multiprocessor system according to claim 15, wherein
the cache system includes a tag unit in which cache-line tag information on the cache data is stored, and
the tag unit invalidates the cache-line tag information corresponding to the cache line in which failure is detected, when updating the cache-line tag information.

17. The multiprocessor system according to claim 15, wherein
the failure detecting unit includes
an instruction-data checksum calculating unit that calculates an instruction data checksum that is a checksum of the instruction data,
a line-data checksum calculating unit that calculates a line data checksum that is a checksum of the cache data, and
a comparing unit that compares the instruction data checksum with the line data checksum.

18. The multiprocessor system according to claim 15, further comprising a task distributing unit that performs distribution of tasks to the processors in accordance with a frequency at which failure is detected by the failure detecting unit.

19. The multiprocessor system according to claim 18, wherein the task distributing unit is a software kernel that distributes software processes to each of the processors.

20. The multiprocessor system according to claim 18, wherein the task distributing unit performs the distribution of the tasks to each of the processors from an evaluation function in which a count value of number of times of detecting failure is used as a parameter.
